(19) United States
(12) Patent Application Publication
(10) Pub. No.: US 2013/0052506 A1
(43) Pub. Date: Feb. 28, 2013

(54) BATTERY ARRANGEMENT AND METHOD FOR THE PRODUCTION THEREOF

(71) Applicant: LI-TEC BATTERY GMBH, Kamenz (DE)

(72) Inventors: Andreas GUTSCH, Luedinghausen (DE); Tim SCHAEFER, Niedersachswerfen (DE); Claus-Rupert HOHENTHANNER, Hanau (DE); Andreas FUCHS, Leipzig (DE); Walter LACHENMEIER, Sankt Augustin (DE)

(73) Assignee: LI-TEC BATTERY GMBH, Kamenz (DE)

(21) Appl. No.: 13/661,667

(22) Filed: Oct. 26, 2012

Related U.S. Application Data
(63) Continuation of application No. 13/417,701, filed on Mar. 12, 2012, now abandoned.
Application No. 13/417,701 is a continuation of application No. 13/379,259, now abandoned.

(30) Foreign Application Priority Data
Jun. 19, 2009 (DE) 10 2009 025 579.6

(51) Int. Cl. H01M 2/06; H01M 2/20; H01M 10/50

(52) U.S. Cl. 429/120; 429/179; 29/623.1

(57) ABSTRACT

The invention relates to a battery arrangement (1) comprising at least one, but particularly a plurality of electrochemical cells (2), the at least one electrochemical cell (2) comprising at least one current conductor (3) extending through a casing (4) of the electrochemical cell (2), characterized in that said at least one current conductor (3) is electrically conductively connected to at least one connecting pin (5).

### CROSS-REFERENCE TO RELATED APPLICATIONS

This is a continuation application of U.S. Ser. No. 13/417,701 filed Mar. 12, 2012, which is a continuation application of U.S. Ser. No. 13/379,259 filed Dec. 19, 2011, the entire contents of each of which are incorporated herein by reference. U.S. Ser. No. 13/379,259 is a National Stage of PCT/EP10/03102 filed May 20, 2010, and claims priority to German Application No. 10 2009 025 579.6 filed Jun. 19, 2009.

### DESCRIPTION

The invention relates to a battery arrangement and a method for the production of a battery arrangement.

### BACKGROUND

DE 10 2007 031 674 A1 makes known an electrochemical energy storage unit which comprises a plurality of flat cells. The flat cells comprise at least two current collectors and one casing. Current collectors of adjacent flat cells are electrically interconnected by way of a connecting element. The connecting element has thermal contact with a heat sink. The heat sink is connected to a connecting element in a form-fit or non-positive manner by way of a rivet. The rivet is made of plastic.

WO 2008/016568 A2 makes known an electrochemical cell which comprises a positive electrode, a negative electrode, a separator and an electrolyte. These elements are disposed in a casing. Electric contact is established between a contacting surface and one of the electrodes by way of a longitudinal object in the form of a nail.

### SUMMARY

The problem addressed by the present invention is that of providing an improved battery arrangement.

The problem addressed by the invention is solved by a battery arrangement comprising at least one, but in particular a plurality of electrochemical cells, wherein at least one electrochemical cell comprises at least one current collector extending through a casing of the electrochemical cell, characterized in that this at least one current collector is electrically connected to a connecting pin.

The connecting pin is preferably a component which is separate from the electrochemical cell and, therefore, the current collector, which preferably does not penetrate the casing of the electrochemical cell. A connecting pin is understood to mean, in particular, an elongated object which has a cylindrical body in particular, wherein the basic surface of the cylindrical shape can preferably be a circular disk or a polygon. The body has a cross section that remains consistent along the axial length thereof in particular. Alternatively, the cross section can also taper slightly, in particular in the axial direction, to form a tip. The axial length of the body is preferably many times greater than the cross-sectional thickness of the body. At one end, the connecting pin preferably has a tip, thereby enabling it to be passed through other objects, preferably more easily. At another end of the body, the connecting pin has a flattened contact surface, in particular, which serves as an engagement surface for a tool, by way of which the connecting pin can be accelerated in the direction of the axial orientation thereof, abruptly in particular. As an alternative to the flattened point, the connecting pin can also be acted upon with force along the body thereof, or can comprise another engagement surface for the application of an impulse. The body can comprise a homogeneous circumferential surface which, however, can also be interrupted by individual notches or other types of unevenness. The connecting pin is preferably hardened on the surface thereof. It can also have a soft core. The connecting pin can be in the form of a nail or substantially have the outer shape of a nail. The surface of the connecting pin, at least, in particular the entire connecting pin, is made of a conductive material, in particular a metal which is preferably hardened.

The contacting of the current collector to the connecting pin is simplified since, preferably, the connecting pin can be easily connected to the current collector in an electrically conductive manner by applying force in a targeted manner.

A casing within the scope of the invention is understood to mean an at least partial boundary which delimits at least one electrode stack to the outside. The casing is preferably gas-tight and fluid-tight, thereby ensuring that material cannot be exchanged with the surroundings. The electrode stacks are disposed within the casing. At least one current collector, in particular two current collectors, extend out of the casing and serve to connect the electrode stack. The current collectors extending to the outside are preferably the positive pole connection and the negative pole connection of the electrochemical cell. However, a plurality of current collectors can also extend out of the casing, in particular four current collectors. If the electrochemical cell comprises two electrode stacks interconnected in series, then two electrodes of different electrode stacks are interconnected.

Within the scope of the invention, an electrode stack refers to a device which also serves, as an assembly of a galvanic cell, for the storage of chemical energy and for the delivery of electric energy. Before electric energy is delivered, stored chemical energy is converted to electric energy. During charging, the electric energy supplied to the electrode stack or the galvanic cell is converted into chemical energy and stored. To this end, the electrode stack comprises a plurality of layers, at least one anode layer, a cathode layer and a separator layer. The layers are placed or stacked one above the other, wherein the separator layer is disposed at least partially between an anode layer and a cathode layer. Preferably, this sequence of layers is repeated many times within the electrode stack. Preferably, a few electrodes are interconnected, electrically in particular, being connected in parallel in particular. The layers are preferably wound to form an electrode coil. In the following, the term “electrode stack” will also be used for electrode coil.

A current collector is an element made of a current conducting material. It serves to conduct current between two points which are separated from one another geometrically. In the present case, a current collector is connected to an electrode stack. In particular, the current collector is connected to all similar electrodes of an electrode stack, i.e. either to the cathodes or the anodes. It is understood that a current collector is not connected to the cathodes and the anodes of an electrode stack simultaneously since this would cause a short circuit. However, a current collector can be connected to different electrodes of different electrode stacks, e.g. in a series connection of the two electrode stacks. At least one current collector extends out of the casing and can be used for connecting the electrochemical cell to the outside. The current collector can be formed as one piece with one or more electrodes.

Preferably, current collectors of different, in particular adjacent electrochemical cells are interconnected in an electrically conductive manner by way of a connecting pin. The advantage of the contacting of a single current collector is therefore applied to the connection of two current collectors, in particular for the purpose of connecting the associated electrochemical cells in series or in parallel. Two or more electrochemical cells can be electrically interconnected in particular by way of a targeted force application or an impulse with the aid of a single connecting pin. This takes place preferably in a single method step. It is understood that this type of connection is not limited to two electrochemical cells, but rather can be applied to a plurality of electrochemical cells which can be interconnected in an electrically conductive manner in one method step.

The connecting pin preferably penetrates at least one current collector at least partially. The connecting pin can penetrate a plurality of current collectors simultaneously. The current collectors are disposed along the axial orientation of the body of the connecting pin. Since the current collector is penetrated by the connecting pin at least partially, a secure and reliable connection between the connecting pin and the current collector can be established. The expression “penetrate at least partially” means that the connecting pin does not need to be enclosed entirely by the current collector, although it can be. Instead, the connecting pin can also rest only against notch of the current collector which rests against the outside, and therefore be electrically connected to the current collector at only one point. It is preferable, however for the connecting pin to penetrate the current collector completely, i.e. for the connecting pin to be enclosed by the current collector in an annular manner at least at an axial point. This does not mean that the connecting pin must be enclosed by the current collector on the entire outer surface thereof.

The connecting pin preferably penetrates the current collector in an opening only partially, wherein a crater is formed in particular around the opening. The opening can be initially created by the connecting pin penetrating the current collector. In that case, the current collector would not comprise an opening before the manufacturing process. Alternatively, the current collector can comprise an opening before the manufacturing process, which, however, is preferably smaller in diameter than the diameter of the body of the connecting pin. In both cases, the penetration by the connecting pin during the manufacturing process causes the opening to expand. The expansion of the opening which takes place during penetration causes the current collector to deform plastically, partially in particular, and elastically, partially in particular, in the region of the opening. By way of the elastic deformation, the current collector can fit tightly against the connecting pin in the region of the opening, thereby ensuring a stable electric connection between these two components. By way of the plastic deformation in particular, a crater can form that can be characterized, in particular, in that it forms a point of the current collector in the region of the opening, which has a greater expansion in the cross section than the current collector in other regions in which the current collector was not plastically deformed. By expanding the cross-sectional thickness in the region of the crater, it is also possible to establish an improved electric connection between the current collector and the connecting pin.

The current collector is preferably accommodated at least partially in a bleed chamber. The bleed chamber which is preferably disposed outside of the casing of the electrochemical cell forms a receiving space for the current collector, in which the latter can be held in a manner such that it is protected from environmental influences in particular. In addition, further devices for contacting can be provided in the bleed chamber. A separate bleed chamber can be provided for each electrochemical cell. However, the bleed chambers of several electrochemical cells can also be combined to form one common bleed chamber which is large in particular.

Preferably, one bleed chamber comprises one opening, in particular when a plurality of electrochemical cells each have a separate bleed chamber. The connecting pin can be routed through the opening from outside the bleed chamber in the direction of the current collector, in particular during the manufacturing process. A tool for installing the connecting pin, in particular a tool for applying an impulse to the connecting pin, can be disposed outside of the bleed chamber, and therefore the force application takes place outside of the bleed chamber. Preferably, openings of bleed chambers of adjacent electrochemical cells are aligned with one another. Preferably, these openings of the bleed chambers of adjacent electrochemical cells overlap one another. A connecting pin which extends through the opening of one electrochemical cell can therefore also extend through the opening of the other electrochemical cell. Additional electrochemical cells can also be provided, the openings of the bleed chambers of which are separated from one another with regard to orientation and placement. As a result, one connecting pin can penetrate a plurality of bleed chambers simultaneously and be electrically connected to the current collectors disposed there.

Preferably, the connecting pin is in contact with metal foam, in particular being at least partially enclosed thereby. The metal foam is preferably disposed in a bleed chamber and fills it completely in particular. The metal foam can be useful for improved contacting between the current collector and the connecting pin. Metal foam refers to a preferably porous conductive foam which is characterized in particular by good electric conductivity combined with low weight. The metal foam can be hardened.

Alternatively or in combination therewith, the connecting pin can be in contact, at least directly, with a heat conducting body made of a heat conducting material in particular, in particular being at least partially enclosed by this heat conducting body. A further element, in particular a layer of metal foam, can be disposed between the heat conducting body and the connecting pin. The heat conducting body is preferably made of a pore-free material, which can help to improve thermal conductivity.

Preferably, cooling fins can be formed on the heat conducting body, which are useful in particular for improved heat dissipation away from the heat conducting body. A ventilation channel is preferably provided in the region of the cooling fins. Preferably, the heat conducting body can be disposed in the bleed chamber. It can extend into a plurality of bleed chambers. A single heat conducting body can be allocated to a plurality of electrochemical cells simultaneously.

The problem addressed by the invention is furthermore solved by a method for manufacturing a battery arrangement, characterized in that current collectors of the battery arrangement are brought into an electrically conductive connection with a connecting pin.

Preferably, current collectors of different, in particular adjacent electrochemical cells can be interconnected in an electrically conductive manner by way of a connecting pin.

The connecting pin can be routed through the current collector, at least partially, during the method for manufacturing a battery arrangement. Specifically, the connecting pin can be routed through an opening in the current collector.

Preferably, the opening is formed initially when the connecting pin is routed through the current collector. Alternatively, the opening can be formed in the current collector even before the penetration. This has the advantage that the opening can be used as a centering aid for the connecting pin during and/or before the connecting pin is routed through the current collector. Furthermore, the force required to route the connecting pin through the current collector is reduced.

When the connecting pin is routed through the current collector, the opening deforms plastically and/or elastically at least partially, in particular in the region of the opening. When the connecting pin is routed through the current collector, a crater can form on the current collector, in particular at an opening.

Preferably, the connecting pin is shot through the current collector, at least partially. By way of the shooting-through, a plastic and/or elastic deformation of the current collector is preferably created. Furthermore, the shooting-through enables a plurality of current collectors to be penetrated by the same connecting pin in one method step. The contacting of a plurality of current collectors can be simplified as a result.

During the method for the production of the battery arrangement, the connecting pin is preferably passed through an opening in the bleed chamber of the electrochemical cell. The connecting pin can therefore enter the bleed chamber and come into contact with the current collectors disposed there. If a plurality of openings in bleed chambers of adjacent electrochemical cells are oriented in alignment with one another and/or adjoin one another, the connecting pin can come into contact simultaneously with a plurality of current collectors which are in alignment with one another.

Once the connecting pin has been brought into electrically conductive contact with at least one current collector, the region around the connecting pin can be filled at least partially with metal foam. The metal foam can thereby preferably come into contact with the current collector and the connecting pin. In particular, a bleed chamber is filled with metal foam at least partially, in particular completely.

### BRIEF DESCRIPTION OF THE DRAWINGS

The invention is explained in greater detail below with reference to the following figures. They show:

FIG. 1 a battery arrangement according to the invention, in a first embodiment

a) in a cross section,

b) from above;

FIG. 2 a battery arrangement according to the invention, in a second embodiment

a) in a cross section,

b) from above;

### DETAILED DESCRIPTION

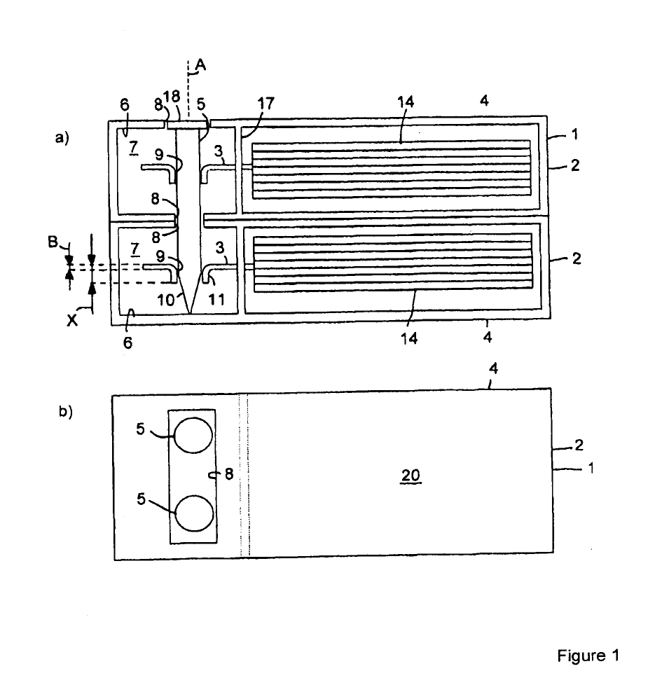

FIG. 1 shows, schematically, a battery arrangement 1 according to the invention, in a first embodiment which comprises two electrochemical cells 2. Moreover, the battery arrangement 1 can also comprise a plurality of electrochemical cells 2. The electrochemical cells 2 are substantially identical in design. Every electrochemical cell 2 comprises a casing 4 which delimits an electrode stack 14 to the outside. On an end face 17 of the electrochemical cell 2, a current collector 3 penetrates the casing 4 of the electrochemical cell 2 and therefore extends from an interior of the casing 4 of the electrochemical cell 2 into an inner space of a bleed chamber 6, as explained in greater detail in the following. The current collector 3 is made of a conductive material and is connected in an electrically conductive manner to at least parts of the electrodes of the electrode stack 14.

The bleed chamber 6 is disposed on the end face 17 of the casing 4 of the electrochemical cell 2. The bleed chamber itself is not part of the casing since the inner space of the bleed chamber 6 does not necessarily need to be hermetically sealed with respect to the surroundings, although it can be.

A connecting pin 5 extends into the bleed chamber 6, which was routed through an opening 8 in a periphery of the bleed chamber 6. The connecting pin 5 penetrates the current collector 3 of the electrochemical cell in an opening 9. The connecting pin 5 was shot through the current collector 3, thereby plastically and elastically deforming the current collector. The opening 9 is initially creating during the shooting-through. This means, furthermore, that the current collector 3 did not have an opening 9 before the shooting-through. Alternatively, an opening 9 can have been formed in the current collector before the shooting-through, thereby simplifying the shooting-through. In particular, the force required for the shooting-through can be reduced; furthermore, the connecting pin 5 can be centered by way of the opening 9.

Furthermore, the shooting-through resulted in a crater 11 forming at the opening 9 by way of the deformation. The crater 11 is characterized in that it has an extension X along an opening direction which corresponds to the longitudinal axis A of the connecting pin 5, which is greater than a cross-sectional thickness B of the current collector 3 at another, non-deformed point of the current collector 3. At the crater 11, the current collector 3 rests largely against the connecting pin 5 in an electrically conductive manner. For the application of force to the connecting pin 5, the connecting pin 5 comprises a plate 18 which is disposed on the side of the connecting pin 5 facing away from the tip 10 in the axial direction. The design of the connecting pin 5 therefore largely corresponds to the design of a nail. As shown, the two electrochemical cells 2 of the battery arrangement 1 rest against one another. Openings 8 in the bleed chambers 6 of both electrochemical cells 2 of the battery arrangement 1 overlap one another. Specifically, the openings are oriented coaxially to the longitudinal axis A of the connecting pin 5, and therefore the connecting pin 5 is routed through both bleed chambers 6 of both electrochemical cells 2 of the battery arrangement 1. The connecting pin 5 extends through each current collector 3 of the two electrochemical cells 2 in the manner described above. Since the connecting pin 5 is connected in an electrically conductive manner to the current collectors 3 at least in parts of the surface thereof, there is an electric connection between the current collectors 3 of the two electrochemical cells 2, which are shown. The electrochemical cells 2 of the battery arrangement 1 can thereby be connected to one another in series, in particular, or in parallel. Consumers, which are not depicted, are connected to the connecting pin 5.

The inner space of the bleed chambers 6 is filled completely with metal foam 7. This metal foam 7, which is connected in an electrically conductive manner to the current collectors 3 and to the connecting pin 5, increases the electric connection between the current conductors 3 and the connecting pin 5.

It is understood that the battery arrangement 1, which comprises two electrochemical cells 2, is depicted merely as an example. A plurality of electrochemical cells can easily be used, which can be electrically interconnected in the same manner. It is also entirely possible for one connecting pin 5 to penetrate more than two current collectors 3 simultaneously.

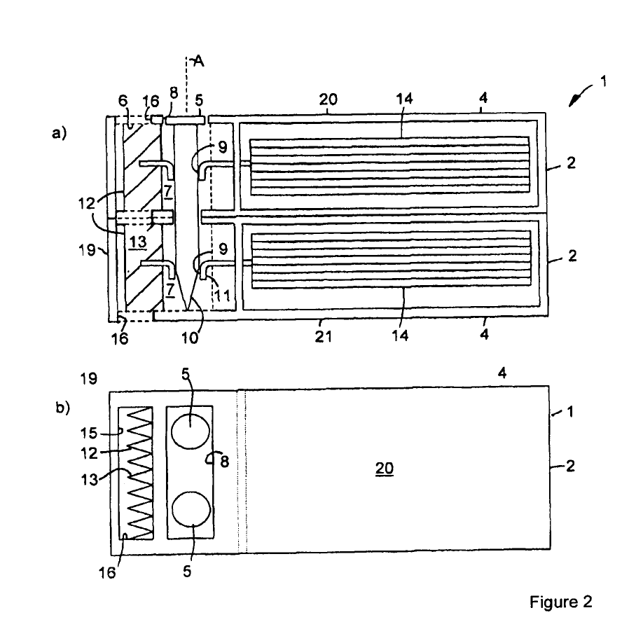

FIG. 2 shows, schematically, a battery arrangement according to the invention in a second embodiment which is a development of the battery arrangement shown in FIG. 1, and corresponds largely thereto. Reference is therefore made to the description therefor. In the following, therefore, only the differences in the second embodiment relative to the first embodiment will be discussed.

The bleed chambers 6 of the electrochemical cells 2 are therefore filled only partially with metal foam 7. The region filled with metal foam 7 is limited to a tubular section which is disposed coaxially to the longitudinal axis A of the connecting pin 5. The metal foam 7 therefore encloses the connecting pin 5 only in the region in which the connecting pin 5 is located in the bleed chamber 6. Alternatively or in addition thereto, the metal foam 7 can also enclose the current collector 3 completely or partially within the bleed chamber 6.

Furthermore, a heat conducting body 12 is disposed in a region of the bleed chamber 6 facing away from the electrode stack 14, which is contacted indirectly with the connecting pin 5. The heat conducting body 12 has direct contact with the metal foam 7, which, in turn, has direct contact with the connecting pin 5. Cooling fins 13 are disposed on the heat conducting body 12. The cooling fins 13 extend away from the direction of the connecting pin 5 in the direction of an air channel 15 which is disposed between the cooling fins 13 and an end-face periphery 19 of the electrochemical cell 2. The air channel 15 extends from one opening 16 in a top side 20 to a further opening 16 in an underside 21 in parallel to the longitudinal axis A. The cooling fins likewise extend parallel to the longitudinal axis A. The forementioned advantages result.

### LIST OF REFERENCE CHARACTERS

1 Battery arrangement
2 Electrochemical cell
3 Current collector
4 Casing
5 Connecting pin
6 Bleed chamber
7 Metal foam
8 Opening
9 Opening
10 Tip
11 Crater
12 Heat conducting body
13 Cooling fins
14 Electrode stack
15 Air channel
16 Opening
17 End face
18 Plate
19 End-face periphery
20 Top side
21 Underside
A Longitudinal axis
X Extension
B Cross-sectional thickness

1. A battery arrangement comprising:
at least one electrochemical cell wherein the at least one electrochemical cell comprises at least one current collector extending through a casing of the at least one electrochemical cell,
wherein the at least one current collector is electrically conductively contacted to a connecting pin, and
the connecting pin is enclosed at least partially by metal foam.

2. The battery arrangement according to claim 1, wherein the metal foam is disposed in a bleed chamber and fills it completely.

3. The battery arrangement according to claim 1, wherein the connecting pin is at least in indirect contact with a heat conducting body made of heat-conducting material in particular.

4. The battery arrangement according to claim 1, wherein cooling fins are formed on the heat conducting body.

5. The battery system according to claim 4, wherein current collectors of different electrochemical cells are interconnected in an electrically conductive manner using a connecting pin.

6. The battery arrangement according to claim 1, wherein the connecting pin penetrates at least one current collector at least partially.

7. The battery arrangement according to claim 6, wherein the connecting pin penetrates the current collector in an opening at least partially and forms a crater.

8. The battery arrangement according to claim 1, wherein the at least one current collector is accommodated, at least partially, in a bleed chamber.

9. The battery arrangement according to claim 8, wherein the bleed chamber is disposed outside of the casing of the electrochemical cell.

10. The battery arrangement according to claim 8, wherein the bleed chamber has an opening.

11. The battery arrangement according to claim 9, wherein openings of bleed chambers of adjacent electrochemical cells are aligned with one another.

12. A method for the production of a battery arrangement, in which current collectors of the battery arrangement are brought into electrically conductive connection with a connecting pin, comprising:
routing the connecting pin at least partially through at least one current collector; and
plastically and/or elastically deforming the current collector, at least partially, when the connecting pin is routed through the current collector.

13. The method according to claim 12, wherein current collectors of different electrochemical cells are interconnected in an electrically conductive manner using a connecting pin.

14. The method according to claim 12, wherein, when the connecting pin is routed through the current collector, a crater forms on the current collector.

15. The method according to claim 12, wherein the connecting pin is passed through the current collector, at least in part.

16. The method according to claim 12, wherein the connecting pin is routed through an opening of a bleed chamber of the electrochemical cell.

17. The battery arrangement according to claim 1, wherein the at least one electrochemical cell includes a plurality of electrochemical cells.

18. The battery arrangement according to claim 3, wherein the connecting pin is in direct contact with the heat conducting body.

19. The battery arrangement according to claim 5, wherein the different electrochemical cells are adjacent electrochemical cells.

20. The battery arrangement according to claim 6, wherein the connecting pin penetrates a plurality of current collectors at least partially.

21. The battery arrangement according to claim 7, wherein the crater is formed around the opening.

22. The method according to claim 12, wherein the connecting pin is routed at least partially through an opening in the at least one current collector.

23. The method according to claim 22, wherein the at least one current collector is plastically and/or elastically deformed in a region of the opening.

24. The method according to claim 13, wherein the different electrochemical cells are adjacent electrochemical cells.

25. The method according to claim 14, wherein the crater forms at an opening in the current collector.
